(19) United States
(12) Patent Application Publication
(10) Pub. No.: US 2001/0003214 A1
(43) Pub. Date: Jun. 7, 2001

(54) Method and apparatus for utilizing closed captioned (CC) text keywords or phrases for the purpose of automated searching of network-based resources for interactive links to universal resource locators (URL's)

(76) Inventors: Vijnan Shastri, Encinitas, CA (US); Ashwani Arya, San Diego, CA (US); Sumanth Sampath, San Diego, CA (US); Rinku Bharadwaj, San Diego, CA (US); Parul Gupta, Oceanside, CA (US)

Correspondence Address: Donald R. Boys, P.O. Box 187, Aromas, CA, 95004, US

(21) Appl. No.: 09/727,837

(22) Filed: Nov. 30, 2000

Related U.S. Application Data
(63) Continuation-in-part of application No. 09/586,538, filed on May 31, 2000.
Application No. 09/586,538 is a continuation-in-part of application No. 09/354,525, filed on Jul. 15, 1999.

(51) Int. Cl. H04N 7/173; H04N 7/084; H04N 7/087

(52) U.S. Cl. 725/109; 725/136; 348/478

(57) ABSTRACT

A system for finding URLs for sites having information related to topics in a video presentation has an extractor extracting closed-caption (CC) text from the video presentation, a parser parsing the CC text for topic language, and a search function using the topic language from the parser as a search criteria. The search function searches for WEB sites having information matching the topic language, returns URLs for WEB sites found, and associates the URLs with the topic language. In some cases there is a hyperlink generator for creating hyperlinks to the WEB sites returned, and the system displays the hyperlinks with a display of the video presentation. In a preferred embodiment the video presentation is provided in a first window in the display, thumbnails are displayed in a second window, each thumbnail representing a new topic, and the hyperlinks are displayed in a third window. The hyperlinks are displayed in the third window when the video presentation in the first window is in the particular topic related to the hyperlinks, or when a user does a mouseover of a thumbnail representing the topic to which the hyperlinks are related.

### CROSS-REFERENCE TO RELATED DOCUMENTS

The present invention is a continuation-in-part (CIP) to a patent application bearing Ser. No. 09/586,538 entitled “Method and Apparatus for Indicating Story-Line Changes by Mining Closed-Caption-Text” filed May 31, 2000 which is a CIP) to patent application Ser. No. 09/354,525 entitled “Media-Rich Interactive Video Magazine” filed on Jul. 15, 1999, disclosurea of which are incorporated herein by reference.

### FIELD OF THE INVENTION

The present invention is in the field of video broadcasting, and pertains more particularly to methods and apparatus for searching out and obtaining interactive links to universal resource locators (URL's) for presentation in a media-rich interactive video magazine based on the mining of closed caption (CC) text for keywords or phrases for use in data searches.

### BACKGROUND OF THE INVENTION

With continuing development of new and better ways of delivering television and other video presentations to end users, and parallel development of computerized information systems, such as the Internet and the associated World Wide Web (WWW), there have been concerted efforts to integrate various systems to provide enhanced information delivery and entertainment systems. For example, developers are introducing integrated systems combining TVs with computer subsystems, so a TV may be used as a WEB browser, or a PC may be used for enhanced TV viewing.

In some systems computer elements, such as a CPU, memory, and the like, are built into the familiar chassis of a TV set. In such a system, the TV screen becomes the display monitor in the computer mode. In such a system, conventional TV elements and circuitry are incorporated along with the computer elements, and capability is provided for a user to switch modes, or to view recorded or broadcast video with added computer interaction. One may thus, with a properly equipped system, select to view analog TV programs, digital TV programs, conventional cable TV, satellite TV, pay TV from various sources, and browse the WWW as well, displaying WEB pages and interacting with on-screen fields and relational systems for jumping to related information, databases, and other WEB pages. The capabilities are often integrated into a single display, that is, one may view a broadcast presentation and also have a window on the display for WEB interaction.

In some other systems, computer elements are provided in an enclosure separate from the TV, often referred to in the art as a set-top box. Set-top box systems have an advantage for providers in that they may be connected to conventional television sets, so end users don't have to buy a new TV along with the computer elements.

In such integrated systems, whether in a single enclosure or as set-top box systems, user input is typically through a hand-held device quite similar to a familiar remote controller, usually having infra-red communication with the set-top box or a receiver in the integrated TV. For computer modes, such as WEB browsing, a cursor is displayed on the TV screen, and cursor manipulation is provided by buttons or other familiar pointer apparatus on the remote. Select buttons are also provided in the remote to perform the familiar function of such buttons on a pointer device, like a mouse or trackball more familiar to computer users.

Set-top boxes and computer-integrated TVs adapted as described above typically have inputs for such as a TV antenna (analog), cable TV (analog or digital), more recently direct-satellite TV (digital), and may also connect to video cassette recorders and to mass storage devices such as hard disk drives and CD-ROM drives to provide a capability for uploading video data from such devices and presenting the dynamic result as a display on the TV screen.

The inventors note that the innovations and developments described above provide enhanced ability to view and interact with video presentations, and that the quality of presentation and efficiency of interaction will be at least partly a function of the computer power provided and the sophistication and range of the hardware and software.

The present inventors have noted that even with the advances in hardware and software so far introduced in the art, there is still considerable room for improvement, and the inventors have accordingly provided a unique interactive video presentation system as a contribution to the art. The interactive video system enables a user to view a media-rich interactive presentation termed an interactive magazine or I-Mag by the inventors.

Digital content presented in the interactive magazine taught by the co-pending and cross-referenced patent specification bearing Ser. No. 09/354,525 listed in the cross-reference section is generated in many instances from broadcast analog content that is converted to digital video during off-line authoring processes. Interactive thumbnails representing entry points to new video content offered in the video magazine are generated using scene-change-detection technologies (SCD) and presentation time stamp (PTS) technologies, both of which are known in the art and to the inventor. SCD uses significant color changes to overall color levels from frame to frame to determine when a new video segment or a significant story change has occurred in a video presentation. In this way, thumbnail pictures may be presented in a user-interface along with the video that is currently playing such that a user may interact with the thumbnails to jump to the represented portion of the video presentation or obtain additional information related to that section of the magazine or video segment.

In combination with SCD software, an off-line video editor must manually group and sort such thumbnail pictures for presentation in the interactive magazine. In many cases, an editor will view a presentation off-line while performing editing processes using automated as well as manual software processes to accomplish the task of completing an interactive magazine that is ready for download to users interacting with a central WEB-based server. Such off-line processing can be time consuming and can, at times, command considerable resources both human and machine.

It has occurred to the inventors that the time and resource dedicated to off-line authoring of raw video content that will eventually be included in an interactive video magazine may be considerably reduced through automated processing. This requires that a more exact method than SCD be used for determining where content changes occur in a standard video presentation. SCD technology, while very helpful, remains a non-exact procedure for determining scene changes requiring human supervision in order to correct mistakes made by the software. Moreover, success of SCD techniques may rely heavily on the type and format of raw content to be authored.

In the cross-referenced application, disclosure of which is included herein in its entirety except for the claims, CC text is mined for the purpose of identifying story-line changes in a video presentation such that they may be marked and presented to viewers actively engaged in viewing an I-Mag. Each interactive thumbnail depicts a new story-line change in an I-Mag presentation. The thumbnails are interactive such that a user, upon selecting a thumbnail, may navigate to that part of the presentation. By a mouse-over of a presented thumbnail, a user may see a text summary of the topic represented by the thumbnail.

The system described in the priority application allows off-line editing processes to be streamlined and more automated because CC mining for story-line changes is more exact than conventional methods such as SCD. Therefore, an editor need not supervise or otherwise manually direct the scene-change process.

Another aspect of creating an I-Mag presentation is retrieving reference links to URLs for sources on a data network and the presentation of such links to users interacting with an I-Mag presentation. Such links are typically obtained through traditional (manual) data-search functions during off-line editing of a presentation. The interactive links are then presented in a convenient pop-up screen or sidebar area of a finished presentation. A user may select any one of such links during interaction with a video presentation and navigate by virtue of network-navigation (browser) software to the URL associated with the selected link.

During off-line editing, human resources must be dedicated to understanding the content of the I-Mag presentation and manually searching for reference material that is related to viewed content on the Internet or other data packet medium. Such manual operation is time consuming and takes away from other editing duties.

Therefore, what is clearly needed is a method and apparatus that can be used to automatically search networks such as the Internet for, and obtain from such network, reference links to URLs (hyperlinks) that are relevant to a topic being presented in an I-Mag. Such a method and apparatus would provide significant automation to the off-line editing process by allowing a video editing person to concentrate on other editing tasks without being required to manually search for and obtain such hyperlinks.

### SUMMARY OF THE INVENTION

In a preferred embodiment of the present invention a system for finding URLs for sites having information related to topics in a video presentation is provided, comprising an extractor extracting closed-caption (CC) text from the video presentation; a parser parsing the CC text for topic language; and a search function using the topic language from the parser as a search criteria,. The system is characterized in that the search function searches for WEB sites having information matching the topic language, returns URLs for WEB sites found, and associates the URLs with the topic language.

In some embodiments a hyperlink generator is provided for creating hyperlinks to the WEB sites returned, and displaying the hyperlinks with a display of the video presentation. In a preferred embodiment the video presentation is provided in a first window in the display, thumbnails are displayed in a second window, each thumbnail representing a new topic, and the hyperlinks are displayed in a third window. In some cases the hyperlinks are displayed in the third window when the video presentation in the first window is in the particular topic related to the hyperlinks. In other cases the hyperlinks are displayed in the third window when a user does a mouseover of a thumbnail representing the topic to which the hyperlinks are related.

In another aspect of the invention a method for finding URLs for sites having information related to topics in a video presentation is provided, comprising steps of (a) extracting closed-caption (CC) text from the video presentation; (b) parsing the CC text for topic language; (c) using the topic language from the parser as a search criteria in a search engine; (d) returning URLs for WEB sites matching the search criteria; and (e) associating the returned URLs with the topic language.

In some embodiments of the method there is a step for generating hyperlinks to WEB sites returned, and displaying the hyperlinks with a display of the video presentation. In a preferred embodiment the video presentation is provided in a first window in the display, thumbnails are displayed in a second window, each thumbnail representing a new topic, and further comprising a step for displaying the hyperlinks in a third window. In some cases there is a further step for displaying the hyperlinks in the third window when the video presentation in the first window is in the particular topic related to the hyperlinks. This may be when the user does a mouseover relative to one of the thumbnails representing a particular topic.

In embodiments of the invention described in enabling detail below, for the first time hyperlinks to sites having information related to a video presentation may be automatically mined and related to topics in the presentation, such that, when viewing a presentation, a user may have a selection of hyperlinks related to a topic in the presentation, with which to access further information on the topic.

### BRIEF DESCRIPTION OF THE DRAWING FIGURES

FIG. 1 is a system diagram illustrating an exemplary architecture for practicing the present invention.

FIG. 2 is a first entry page for a video magazine according to an embodiment of the present invention.

FIG. 3 is an second entry page for the video magazine.

FIG. 4 is a presentation and control page for a presentation provided by the video magazine.

FIG. 5 is a feedback page for feedback from clients in the video magazine.

FIG. 6 is an architectural overview of an off-line video collection and editing process according to an embodiment of the present invention.

FIG. 7 is a block diagram illustrating topic change detection and thumbnail-summary generation software according to an embodiment of the present invention.

FIG. 8 is a screen shot of an I-Mag user-interface illustrating topic-change thumbnails and a topic-summary block according to an embodiment of the present invention.

FIG. 9 is an architectural overview of the off-line video collection and editing process of FIG. 6 enhanced with automated search capabilities according to an embodiment of the present invention.

FIG. 10 is a block diagram illustrating an automated URL search and linking process according to an embodiment of the present invention.

FIG. 11 is a screen shot of the I-Mag user-interface of FIG. 8 further illustrating a section adapted to contain interactive links to URL's according to an embodiment of the present invention.

### DESCRIPTION OF THE PREFERRED EMBODIMENTS

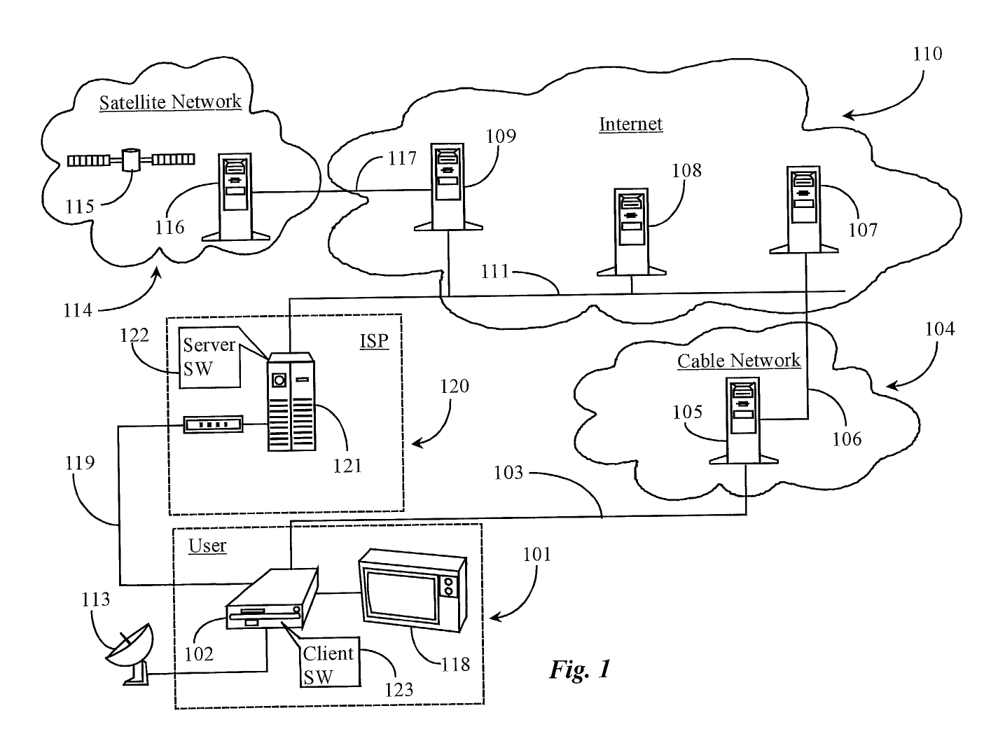

According to a preferred embodiment of the present invention, a media-rich video magazine system is provided for education and entertainment of clients of a presentation service. FIG. 1 illustrates an architecture upon which the video-magazine system may be practiced. In FIG. 1 a user's premise 101 has a display 118, which may be a television set with computer integration, and a set top box 102 enabled to receive video streams, in this case, by three different ports. Video may be received at box 102 via cable link 103 from a cable network 104 having a server 105, which may alternately receive video via an Internet connection 106 for rebroadcast from exemplary Internet servers 107, 108 and 109 in Internet cloud 110, the servers loosely connected on Internet backbone 111. In most cases the cable link is a one-way link not providing a backlink to the user to interact with a video presentation served.

Box 102 in this example also has a satellite port 112 connected to a satellite dish 113 for receiving video streams from a satellite network 114 via a satellite 115 to which video stream is uploaded from a server 116 connected by link 117 to Internet cloud 110, and the box may thereby receive video streams via the satellite link as well. Again, in most conventional cases the satellite link is a one-way link, and no backlink is provided to the user, although the backlink limitation is not inherent.

Box 102 in this embodiment also has a landline telephony modem connection 119 to an ISP 120 through which the box is connected to Internet 110 via server 121. There are other means by which video streams may be received by a user's station and by which the user may backlink to a sender for interaction with the presentation system. FIG. 1 is meant to illustrate several of the more common. In a simple case, as will be apparent with further disclosure below, a user with a PC may receive a video presentation and interact with that presentation according to an embodiment of the present invention through a single connection, such as a conventional Internet connection. Alternatively separate and disparate paths may be used for presentation to a user and user reaction using any of the alternatives apparent in architecture of FIG. 1, or other architectures.

In a preferred embodiment of the present invention a central server, typically a subscription server, is enabled to store and present a media-rich video magazine according to embodiments of the present invention to multiple clients (users). The subscription server may be any of the servers 107, 108, 109 in FIG. 1, server 121 of ISP 120, server 105 of cable station 104, or server 116 of satellite station 114. For illustration only this narrative will assume the subscription server is server 121 in ISP 120, and that all presentation and interaction is via land-line modem link 119. For this description Video Magazine software (Server software) 122 is illustrated as executing on server 121, and client software 123 is shown as executing on box 102.

The skilled artisan will be aware that the client station can take a number of forms, and there will be many client stations not all of the same form. All client stations, however, must be enabled to execute a client software to practice the invention. The arrangement shown is merely exemplary.

The video magazine made available to clients by server 121 (in this embodiment) has abstract features in common with more conventional hard-copy magazines. For example, in both cases authors compose presentations. In the hardcopy magazine the presentations are articles with pictures, while in the interactive video magazine of the present invention the presentations are interactive video presentations with client interactivity mechanisms wherein a viewing client may interact with, manage, and control the presentation. The articles in both cases can be of various kinds, such as documentaries or fiction stories. Both kinds of magazine have editors who assign tasks, control direction and content, and put together the various articles as a periodic new edition of the magazine. In both cases there may be departments and letters to the editor and the like. There are many other similarities.

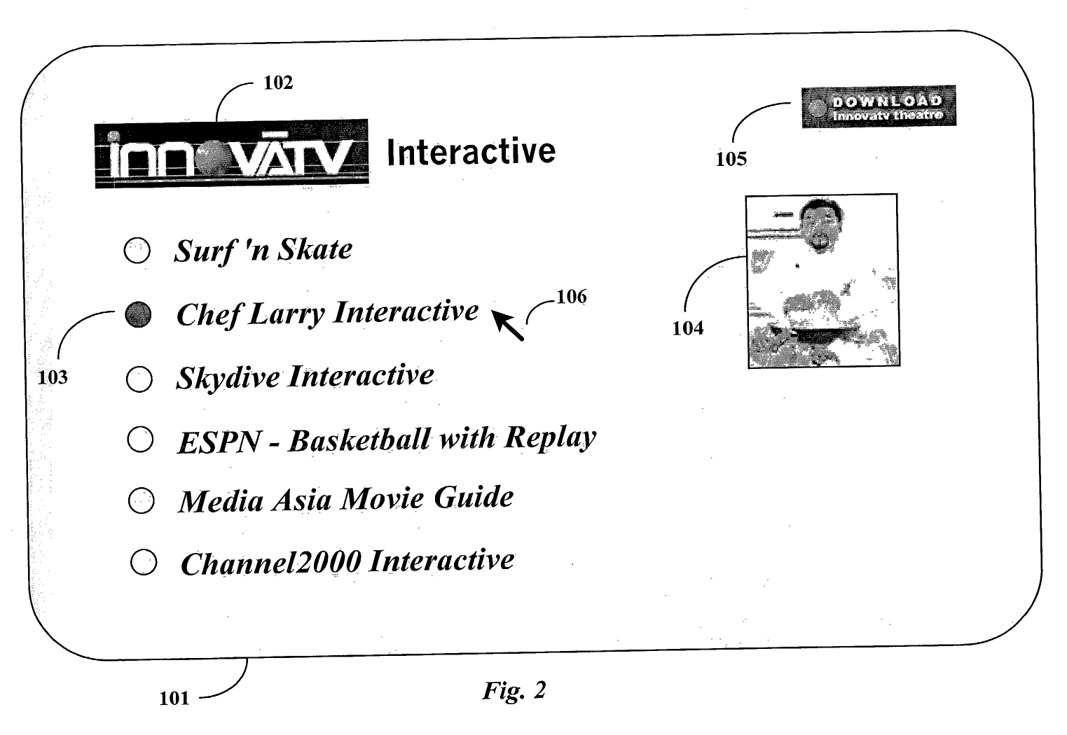

FIG. 2 is a first page of an edition of an exemplary media-rich Interactive magazine according to an embodiment of the present invention. Window 101 is a display on a display screen at a user's station, such as TV 118 of station 101 (FIG. 1). This first page may be considered analogous in some respects to a table of contents for a hardcopy magazine, except this first page has greatly enhanced functionality.

First page 101 has an ID logo 102 identifying this magazine as an edition of Innovatv Interactive magazine. A list of selectable entries 103 comprise the presentations available in the current edition of the magazine. Selection is by moving a cursor 106 to the area of a listing and clicking on the area. A mouseover changes the color of a bullet at the head of each listing, indicating which presentation is about to be selected. The presentation which is thus highlighted also causes a picture to be displayed in a window 104, the picture being indicative of the presentation. In this example the Chef Larry Interactive presentation is highlighted, and a still of Chef Larry is displayed in window 104. A download button 105 is provided in this example enabling a viewer/client to download from the server software for interacting with the server to view magazine presentations. This is, in this embodiment, client software 123 (FIG. 1).

FIG. 2 indicates there are six presentations in the current edition of the magazine, these being, besides Chef Larry Interactive, Surf'n Skate, Skydive Interactive, ESPN-Basketball with Replay, Media Asia Movie Guide, and Channel2000 Interactive.

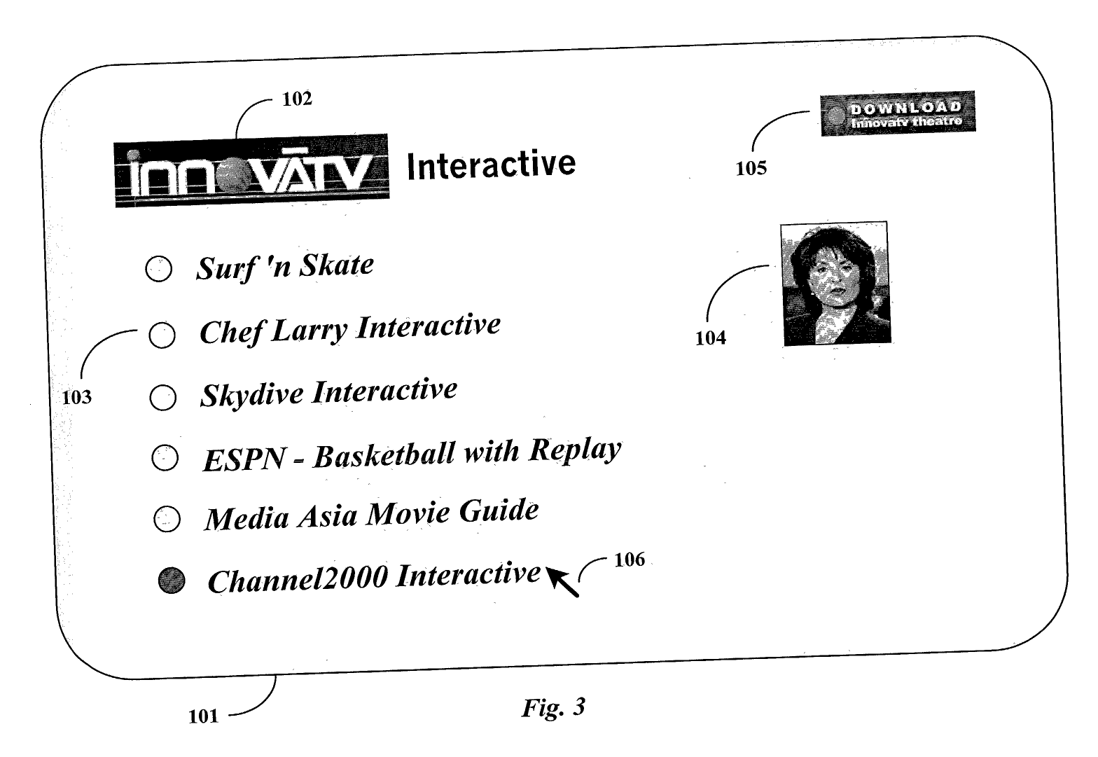

FIG. 3 is another view of first page 101 with cursor 106 moved to highlight Channel2000 Interactive, and it is seen that window 104 now has a new picture, this being a picture of a reporter and narrator for Channel2000 Interactive.

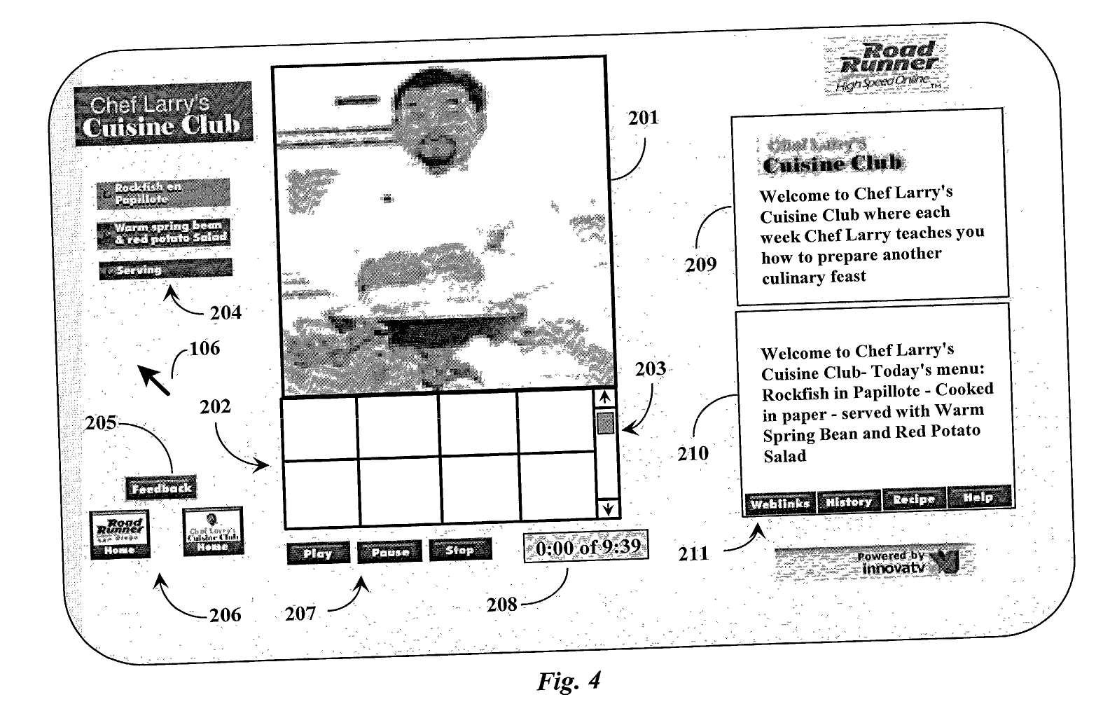

When a client selects one or another of the listed presentations shown in FIGS. 2 and 3, a backlink signal goes to server 121 (FIG. 1), which responds by serving a new page to the client, this being a control and presentation page dedicated to the particular presentation selected. FIG. 4 is the control and presentation page for Chef Larry Interactive, and is described below in enabling detail as representative of all the other presentations available in the magazine, all of the presentations having similar functionality.

The control and presentation page shown has a logo at the upper left for Chef Larry's Cuisine Club. A video window 201 provides an active video presentation selectable and controllable to a large degree by the viewer/client. The video presentation that will play in this case is one of three selectable from list 204. The three selections are Rockfish en Papillote, which shows in detail how to prepare the title dish; Warm Spring Bean and Red Potato Salad, which shows in detail how to make the side dishes to accompany the fish main course; and Serving, which shows the details of serving the courses property and elegantly. Again selection is made by moving cursor 106 and using a pointer device input, such as a mouse. In this particular case the Rockfish en Papillote video is selected.

A dynamic time window 208 shows the current position of the video (0:00) and the total time (9:39) for the video. Play pause and stop buttons 207 are provided to enable the client to start, pause, and stop the video. A Stop signal causes the video to go to the start and wait for a Play signal.

In addition to starting, pausing and stopping, a set of thumbnails 202 is provided. Each thumbnail is a frame of the video at a natural scene change or transition point in the video. These may be thought of as Chapter headings in the video presentation. Note that there are eight thumbnails shown, but a scroll bar 203 enables there to be many more than the eight selectable thumbnails shown. No frames are shown in the thumbnails in FIG. 4 to avoid confusion of too much detail, but in the actual implementation the frames may be seen.

Selecting a thumbnail causes the video presentation to jump to the selected frame, and changes the time window 208 to indicate the time position in the video. Jumps may be from any position in the video to the selected position, and if the video is playing when a jump is made, the video automatically restarts at the jumped-to position. If the video is stopped or paused when a selection is made, the video jumps to the new position and indexes the time window, but waits for a play signal to play the video from the new position. One may thus jump to different related videos and to natural transition position within videos at will.

Window 209 provides additional info and selectable links. The text shown is a general comment for the video. When one selects a link in this window the video, if playing in window 201, goes to pause, and a new window (not shown) opens as a conventional browsing window to the new destination. When one leaves the new destination and closes the browsing window, the video resumes in window 201.

Window 210 provides text information specific to each video segment represented by a thumbnail. A row of buttons 211 across the bottom of window 211 enables a client to select content for this window. Weblinks takes the client to related Web sites, and behavior is as described above for jumps to outside Web sites. History accesses events already past in the video. Recipe provides a printable recipe for the dishes illustrated and taught in the available videos. Help takes the client to a tutorial on how the magazine system works.

Home buttons 206 enable a client to go to one of two selectable home destinations. One if the Chef Larry Cuisine Club home page and the other a RoadRunner home page, which is an access point for interactive magazines of the kind taught herein, and for other content as well.

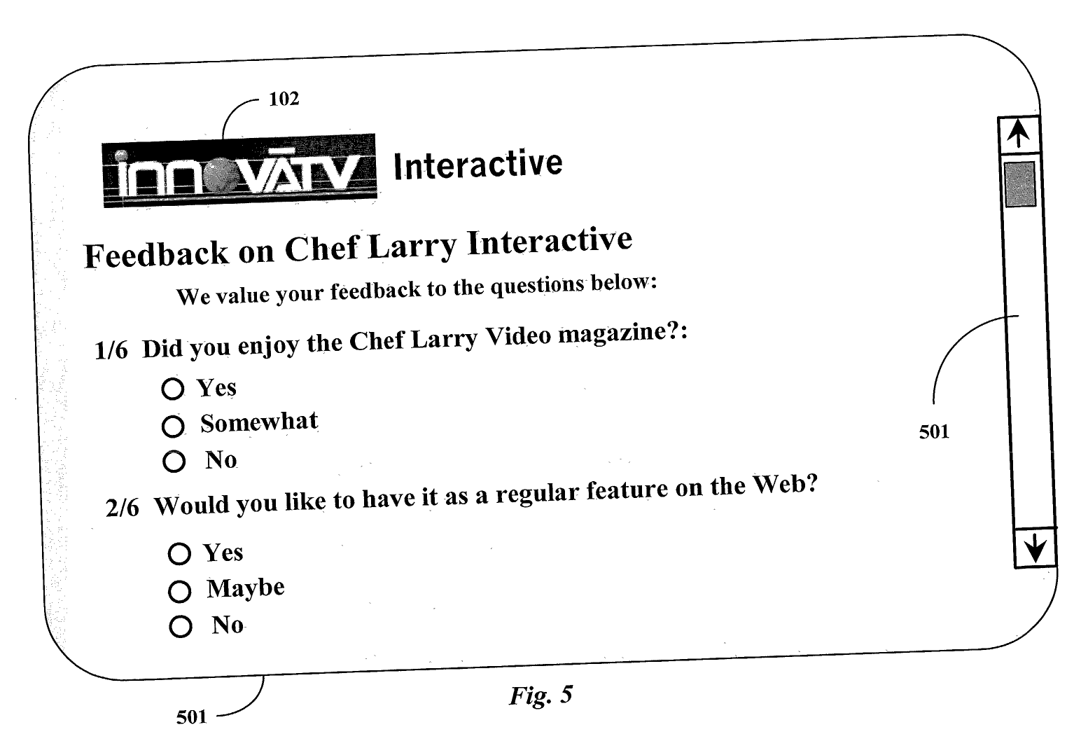

A Feedback button 205 takes a client to a feedback page shown exemplary in FIG. 5. The feedback page enables a client to answer a series of questions providing valuable feedback to the editors of the media-rich magazine. A scroll bar 501 enables the client to access all of the questions in a feedback list.

Just one of six available presentations in a media-rich Interactive Magazine has been taught herein, but the other five, although the appearance and implementation of interactive controls may differ (different backgrounds, different positions, certainly different video content related to the listed titles) the control and flow is similar. In each case a video window (201) is provided, there are Stop, Pause, and Play controls (207), each video presentation is parsed by thumbnails (202), more than one video on the title subject may be selectable (204), and extra windows with extra information and destinations are provided (209 and 210). In alternative embodiment of the present invention a number of video magazines, each having plural presentation content and periodically updated to new content Oust like a hardcopy magazine) may be made available through a subscription server. Again it is emphasized that the invention may be practiced in a variety of equipment configurations, both at the server and the client end. It will be apparent to the skilled artisan that the appearance of entry pages and the appearance and interface mechanisms of both these and the presentation and control pages may vary widely within the spirit and scope of the invention.

CC-Based Topic Change xxx

In another aspect of the present invention, the inventor provides an off-line editing system that substantially automates and improves the process of creating transitions and transition thumbnails, and providing summary information related to those thumbnails for presentation in an interactive magazine. The method and apparatus of this unique editing and presentation process is described in enabling detail below.

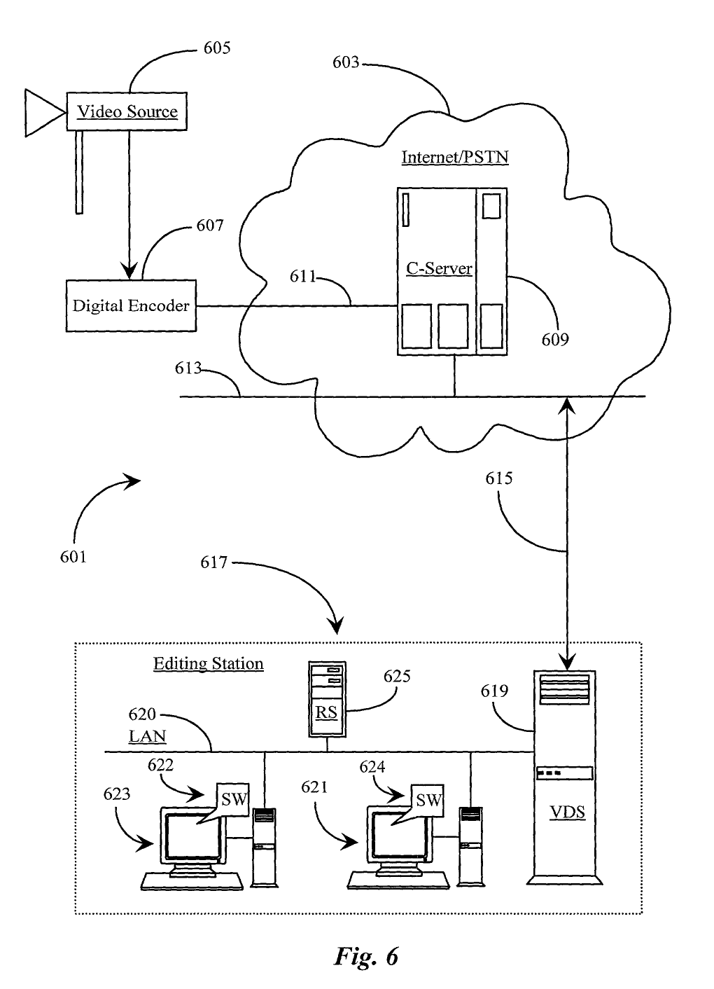

FIG. 6 is an architectural overview of an off-line video collection and editing system 601 according to an embodiment of the present invention. System 601 involves the collection of and editing of raw video content used in preparation of an interactive magazine made available, in this embodiment, for download to users connected to the Internet network illustrated herein as element 603 (Internet/PSTN).

Internet/PSTN network 603 represents a preferred medium for collection of raw video content and redistribution of edited video content to a plurality of connected users. The inventor chooses to illustrate network 603 as an integration of the well-known Internet network and the PSTN network because of the ambiguity concerning the many shared lines and equipment existing in such networks. The fact that network 603 represents the Internet and the PSTN network is exemplary only of a preferred embodiment of the present invention chosen because of the high public access characteristic shared by both mediums. Any wide-area-network (WAN), including the well-known Internet network may be substituted for Internet 603 provided the appropriate data transmission protocols are supported. Moreover, PSTN 603 may be a private rather than a public access telephony network.

System 601 describes a largely automated system using distributed components dedicated toward advancing the goal of the present invention. In this example, an off-line editing station 617 is provided and adapted by virtue of equipment and software for receiving and editing video content into a form acceptable for re-broadcast or Internet-based server-download to users having the appropriate customer premises equipment (CPE).

A video source 605 represents one of many possible sources for raw video content that may be selected for editing and ultimate inclusion into, for example, an interactive magazine ready for presentation. Source 605 may be a cable studio, a television studio, or any other entity having possession of raw video content and equipment for transmitting the content for the purpose of authoring according to an embodiment of the present invention. Typically, source 605 handles a significant amount of analog content such as would be broadcast to public television and analog cable recipients. It is known that such analog content is typically closed-caption-enhanced (CC) for the hearing impaired.

The primary object of the present invention is to exploit CC text for the purpose of generating story-line changes and summary descriptions represented in many cases by thumbnails presented to users as an interactive tool with an interactive magazine presentation. To this end, editing functions of station 617 are limited in description to those functions pertaining particularly to the present invention. However, it will be appreciated that station 617 may perform a variety or other authoring functions and processes known to the inventor.

In this example, video source 605 loads analog video content such as news casts, educational programs and the like into an analog-to-digital encoder machine 607 typically at the site of video source 605. The encoder, however, may be elsewhere in the system. Encoder 607 is adapted to convert analog video content into a digital format suitable for transport over a digital packet network (DPN), in this case, Internet 603.

Encoder 607 has an additional capability provided for detecting and extracting CC text contained typically in the video blanking intervals (VBIs) of the analog video frames, and for recording the presentation time of the occurrence of CC text within the analog video. The output of encoder 607 is digital video organized in compressed data packets such as in the well-known Motion-Picture-Exchange-Group (MPEG) format and separate digital CC text files similarly organized into data packets.

The output from encoder 607 is uploaded, in this example, by virtue of an Internet access line 611 into a video-collection server (C-Server) 609 within Internet 603. It is noted that in some cases analog content may be simply mailed to station 617 for editing purposes. However, the mechanism provided herein and illustrated by system 9 represents an automated enhancement for content delivery as is known to the inventor.

Collection server 609 is adapted to receive digital video and time-stamped CC text files from a plurality of content sources. Source 605 is intended to represent such a plurality. Server 609 is illustrated as connected to an Internet backbone 613, which represents all of the lines and connection points making up the Internet network in a global sense. In this respect, there are no geographic limitations to source 605, or to end users participating in the receipt and interaction with an interactive magazine as taught herein.

Editing station 617 has in this embodiment a video download server (VDS) 619 Server 619 is adapted to receive digital video content as well as digital CC text files from server 609 for video editing purposes in an off-line mode. Data connection between servers 609 and 619 is illustrated by an Internet-access line 615. Line 615 as well as line 611 between server 609 and encoder 607 may be any type of known Internet-access connection wired or wireless. Examples include cable/modem, ISP, DSL, ISDN, satellite, and so on.

Once content is received and (typically) registered in VDS 619, the content may be distributed for editing. A local area network (LAN) 620 is provided in this embodiment within station 617 and illustrated as connected to VDS 619. LAN 620 is adapted to support the appropriate communication and data transmission protocols used for transporting data over the Internet. Connected to LAN 620 are a reference server (RS) 625 and two exemplary editing workstations, workstation 623 and workstation 624. Workstations 623 and 624 are adapted as computer editing machines, which may be automated in some instances and manned in other instances. For the purpose of the present invention it will be assumed that stations 623 and 624 are un-manned and automated when performing the editing processes that are taught further below.

Workstations 623 and 624 are illustrated as computers, each comprising a processor/tower and a connected monitor, which presents a graphical-user-interface (GUI). It is important to note here that a single workstation, if powerful enough, may practice the present invention without the aid of a second station. In this example, however, two workstations are illustrated with each workstation performing different parts of the editing process according to an embodiment of the present invention.

RS 625 is adapted as a server containing reference data used by workstations 623 and 624 in the course of editing. The exact nature of the above-mentioned reference data and the dedicated function of RS 625 is explained further below.

Workstation 623 has an instance of software (SW) 622, which is provided to execute thereon and adapted to edit and process CC text files associated with a digital presentation for the purpose of determining points or junctures representing new topics or story-line-changes contained in the video. Workstation 621 has an instance of software (SW) 624, which is provided to execute thereon and adapted to utilize process results passed to it from workstation 623 for the purpose of selecting keyframes of a digital video segment and generating interactive thumbnails which represent the junctures in the segment where a topic or story line has changed.

By virtue the separate natures of SW 622 and SW 624 as described above, it is noted herein that workstation 623 receives only CC text files from VDS 619 for processing while workstation 621 receives only the digital video segment associated with the CC text files received by workstation 623. In this way, workstations 623 and 621 have a dependent relationship to each other and work in concert to complete editing processes for any given video segment. In this relationship, workstation 621 has a digital player (SW not shown) provided therein and adapted to allow workstation 621 to receive and play digital video for the purpose of selecting keyframes and generating thumbnails representing those keyframes.

In an alternative embodiment, a single instance of SW of the present invention may be adapted with the capabilities of both instances 622 and 624, and may be provided on a single workstation adapted to receive both CC text files and the associated video segments. In this case, workstations 623 and 621 would operate independently from one another and could work on separate video segments simultaneously.

In practice of the present invention, analog video content from source 605 is loaded into digital encoder 607 wherein CC text is extracted from the VBI portions of the video to produce an output of CC text files time stamped to their original locations in the video segment. The analog video is converted to a digitized and compressed video stream. Output from encoder 607 is uploaded into c-server 609 in Internet 603 over access line 611. VDS server 619 retrieves associated video files and CC text files from server 609 over access line 615 either by pull or push technology.

VDS server 619 in this embodiment routes CC text files over LAN 620 to workstation 623 for processing while the associated video files are routed to workstation 621. Workstation 623 running SW 622 processes CC text files according to an embodiment of the present invention and passes the results to workstation 621. Workstation 621 running SW 624, which includes a video player, utilizes CC text results to select keyframes from the video. Workstation 621 then generates interactive thumbnails from the selected keyframes representing topic or story-line-change occurrences in the video. Selected text summaries are interactively linked to each representative thumbnail. The output from workstation 621 is passed on to VDS 619 where it may be uploaded to a video-presentation-server (VPS not shown) connected to backbone 613 and accessible to end-users.

Alternatively, edited content may be sent via digital cable or the like to a video broadcast server for transmission over digital cable to end users according to schedule. In a preferred embodiment, the Interactive magazine of the present invention is held in Internet network 603 at an appropriate VPS server for on-demand user-access by virtue of Internet connection and download capability.

It will be apparent to one with skill in the art that the architecture presented herein may vary somewhat in specific dedication and connection aspects without departing from the spirit and scope of the invention. For example, instead of an editing station having a LAN with individual workstations connected thereto, one powerful server may be provided and adapted to perform all of the automated editing functions described herein.

In one embodiment, source content may be delivered directly to off-line station 617 via digital cable instead of using the Internet as a video collection medium. Likewise, equipment and SW required to create an interactive magazine from source material may be provided at source locations where it may be edited and then delivered directly to broadcast or download points. There are many possibilities. The architecture and connection methods illustrated in this example are intended to represent a configuration that promotes automation and streamlined services according to a preferred embodiment among many possible alternative embodiments.

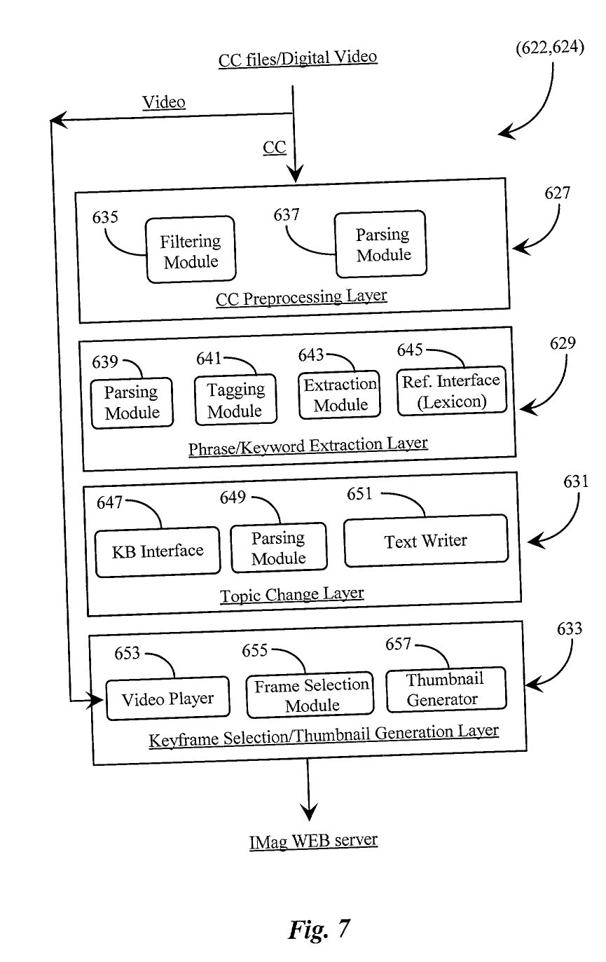

FIG. 7 is a block diagram illustrating topic-change detection and thumbnail-summary generation software 622 and 624 according to an embodiment of the present invention. SW (622, 624) is illustrated as one layered application in this example, however, individual components thereof may be provided in a distributed fashion on more than one machine as was illustrated in FIG. 6 with SW 622 on workstation 623 and SW 624 on workstation 621.

SW (622, 624) comprises at least four SW layers 627, 629, 631, and 633. Each layer 627-633 is presented according to a hierarchical order of function starting from top to bottom. Arriving time-stamped CC files and digital video are split, with CC files going to a CC pre-processing layer 627 and the digital video going to a Keyframe-Selection/Thumbnail Generation layer 633.

Layer 627 acts to pre-process raw CC text such that it is presentable to the next SW layer 629. To this end, layer 627 contains a filter module 635, which is provided and adapted for eliminating unwanted characters present in the CC text that do not comprise actual words or punctuation. Layer 627 also contains a parser module 637, which is provided and adapted to “read” the CC text from each serial file and to identify and tag whole sentences as they appear serially from file to file in serial fashion.

SW layer 629 functions as a phrase and keyword extraction layer as is labeled. Layer 629 acts to identify key nouns, verbs and subjects contained in the CC text. A parsing module 639 is provided and adapted to scan incoming CC sentences identified in layer 627. A reference Lexicon interface 645 is provided and adapted to allow a SW interface to a separate database listing nouns, verbs and phrases. A lexicon (not shown) or other reference library, to which interface 645 allows access, may be provided on a LAN-connected server as represented in FIG. 6 by RS server 625 connected to LAN 620 in editing station 617.

Parser 639 works in conjunction with a tagging module 641 and interface 645 to identify and tag nouns, noun phrases, verbs, verb phrases, subject-nouns, and subject phrases that are contained in the CC text. This process is performed according to rules pre-set by the hosting enterprise. For example, a “noun phrase tag rule” would apply for identifying and tagging all noun phrases containing nouns and so on. Once complete sentences (sentences having a subject and a predicate) are identified and tagged, a phrase extraction module 643 extracts complete sentences from the CC text and forwards them to layer 631 for further processing.

SW layer 631 functions as a topic change decision layer as is labeled. Layer 631 acts to determine when a topic change occurs based on rules including noun comparison as taken from tagged CC text sentences passed to it from layer 629. Layer 631 compares the identified subjects and nouns with most recently entered subjects and nouns with the aid of an adaptive knowledge base (KB). A KB interface module 647 is provided and adapted to allow SW access to a suitable KB.

An adaptive KB (not shown) may be held in RS 625 (FIG. 6) as described above in reference to Lexicon interface 645 of layer 629. A parser module 649 is provided and adapted to read the tagged sentences and to identify the nouns (keywords) contained therein. Parser 649 is similarly adapted to compare the most recent nouns with previously read nouns and indicate a topic change if the nouns do not suitably match. A text writer 651 is provided within layer 631 and is adapted to write a text summary comprising the first sentence or two marking a topic change. The summary will be used to describe a generated thumbnail depicting the new topic change as will be described below.

An example of CC processing for topic change is presented below as might be taken from a news story describing a current disaster. A complete sentence extracted from CC text reads “Hundreds of people are dead, scores more are injured after a devastating earthquake in Taiwan”. Extracted nouns include people, earthquake, and Taiwan. If these nouns are not found in comparing with recent nouns extracted from previous sentences in CC text, then a decision is made that a new topic or story has begun in the newscast. If the same nouns, or significant instances, are found, then the decision is that the topic has not changed.

A next sentence, for example, reads “Taiwan's government is now saying more than 1,500 people have died following the devastating earthquake”. Extracted nouns include Taiwan, government, people, and earthquake. A preponderance of the newly extracted nouns match recently extracted nouns therefore, the topic of the earthquake in Taiwan is still the same and has not changed.

A next extracted sentence reads “Residents along Florida's West Coast are bracing for tropical storm Harvey”. Extracted nouns include residents, Florida, storm, West Coast, and Harvey. None of the newly extracted nouns match most recently extracted nouns. Therefore, there has been a topic change and a new story (about tropical storm Harvey) is being reported. Text writer 651 now utilizes the first few sentences marking the new topic as a summary for a generated thumbnail depicting storm Harvey.

It will appreciated by one with skill in the art that the method and apparatus of the present invention can be used to identify topic or story line changes that occur in a wide variety of video content accompanied by CC text. In this example, a news program was chosen because the occurrence of several significantly unrelated stories in a same video segment provides distinct and clear topical definition from one topic to another. However, it may be that changing from one topic to another is less clearly defined. Such might be the case if two adjacent stories are closely related by nouns such as two separate fires burning in a same state.

An adaptive knowledge base in one embodiment of the invention plays a part in refining topic change techniques by providing more dynamic rules for comparing sentences. For example, if most of the newly entered nouns match those of the previous sentences but a few adjective words are markedly different from the same type of adjective words from previous sentences, then a new topic may be indicated. In an example, using a news coverage of two separate fires, CC phrases from the first story may read “A six thousand acre fire is burning in the Ventura County area at this hour. Mandatory evacuations have been ordered for southern portions of the county”. CC sentences taken from the second story may read “Fire has burned 700 acres in the Shasta Trinity Forrest in Trinity County and continues to grow. There are no plans for immediate evacuations of the area.”

It will be appreciated that the selected CC sentences appear very closely related in noun content. For example, the nouns common to both sets of sentences are fire, acre, area, evacuations and county. Nouns that are different include just Ventura and portions (first set), as opposed to Trinity and Forest (second set). Categorically speaking, the two separate stories fall under the same topic. If judged by nouns alone, the separate stories may be judged as one topic hence no topic change. A generated thumbnail may show the first fire and be annotated with details of the first fire while completely ignoring any detail about the second fire.

By including a rule that considers proper nouns, adjective words and phrases into a categorical knowledge base, it would be clear that “Ventura” County is logically different from and geographically remote from “Trinity” County and that “6000” acres is far different than “700” acres. Therefore, a conflicting flag status indicating more than one logical conflict between the two sets of sentences could be used to indicate the topic change. An adaptive KB may be refined as the process continues by the addition of and categorization of many words and phrases.

The entire process performed by layers 627-631 may be adapted somewhat to the type of CC dialog content loaded into the processing sequence by pre-configuring rules and pre-loading a KB with similar categorical content for comparison. For example, a romantic movie may be judged by such dialog falling under the categories of love scenes, fight scenes, character interaction changes, and so on. There are many possibilities. Moreover, traditional SCD technologies may also be intermittently used where CC dialog is absent or slow.

Referring again to FIG. 7, layer 633 is responsible for key-frame selection and thumbnail generation as labeled. Layer 633 receives indication of a new topic change by presentation time stamp (where the change is indicated in the video segment) from layer 631. Layer 633 also receives a text summary rendered by text writer 651 of layer 631 to be used for annotating a generated thumbnail. As previously described, layer 633 receives the video files associated by reference (time stamp) with the CC text files processed in layers 627-631. A SW video player 653 is provided and adapted to play the video segment frame by frame with capability of indexing to segments or frames indicated by time stamp.

A frame selection module 655 is provided within layer 633 and adapted to select a keyframe appearing after indication of a topic change. A keyframe represents a still shot appearing after a new topic has been detected. Rules regarding the exact keyframe selected are pre-set by the hosting enterprise. For example, in a wholly automated embodiment, the rule may indicate to take the fifth frame after a topic change marker.

In one embodiment, a live editor may randomly check selected frames to make sure they match the new topic. Once a keyframe is identified and selected, a thumbnail generator is provided for the purpose of producing an annotated thumbnail representing the topic change for insertion into an interactive magazine. The annotated portion of a user-selected thumbnail appears in a separate window as the result of a user initiated action such as a “mouse over”, which is a common cursor action. Each generated thumbnail represents a story or topic with the annotation thereof being the first few sentences describing the new topic. Generated thumbnails appear near the main window of an interactive magazine next to each other in logical (serial) order according to how they appear in the video as is further described below.

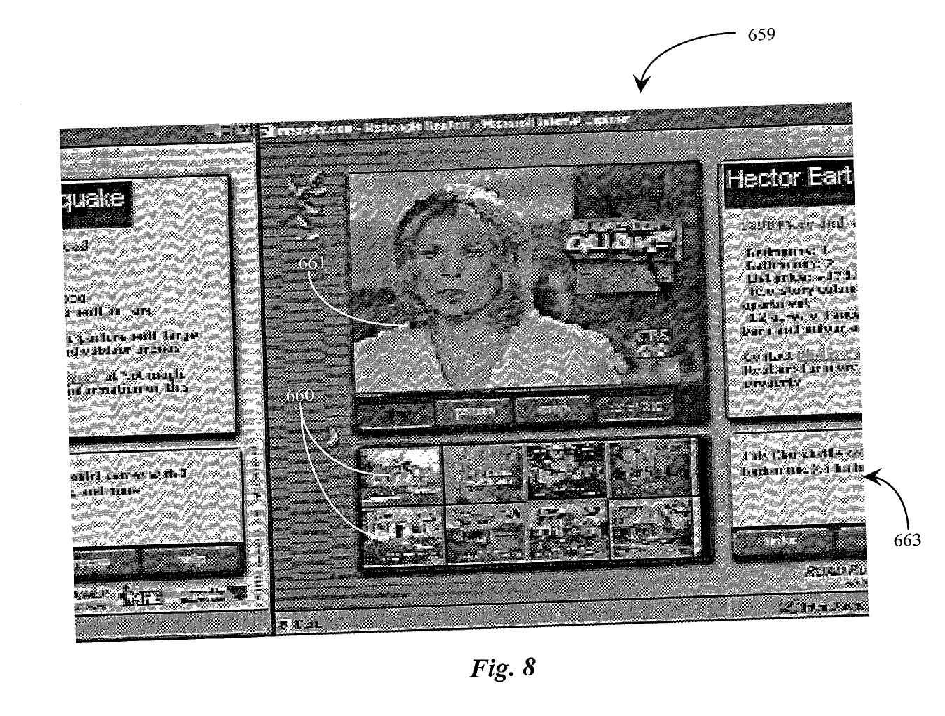

FIG. 8 is an actual screen shot of an I-Mag user-interface illustrating topic-change thumbnails 660 and a topic-summary block 663 according to an embodiment of the present invention. I-Mag 659 appears on a user's monitor display as a playing movie with interactive controls and features accessible through cursor movement and selection. In this example, a news story about an earthquake is playing in a main window 661. Generated thumbnails 660 representing topic changes selected by mining CC text within the story of the earthquake appear below main window 661 and are placed in logical order from top-left to bottom right. If there are more thumbnails than may fit in the area provided for the purpose, then a scroll feature may be added to allow a user to scroll through additional thumbnails.

In this example, listed thumbnails 660 represent topic changes within a same story covering a broad topic. However, it may be that only the first thumbnail represents the earthquake story and the remaining thumbnails 660 each represent different topical stories. This may be the case especially if the stories are very short. In still another example, a combination may be present such as the first three thumbnails representing topic changes in a first story; the fourth and fifth representing changes in a second story; and the sixth through eighth representing changes in a third story, and so on.

Information block 663 is provided as a separate window in this embodiment. Window 663 is adapted to display a summary-text description of a thumbnail when the thumbnail is indicated by a mouse over or other cursor or keyboard action. When a user moves the on-screen cursor over one of thumbnails 660, the appropriate text appears in window 663. If so desired, the user may elect to jump to that portion of the video by clicking on the appropriate thumbnail. A double click may bring up yet additional features like listing relative URL links related to that particular thumbnail. There are many possibilities.

After interactive thumbnails have been created and linked to appropriate annotation summaries, the completed and edited video is packaged and uploaded to an I-Mag WEB server and held for on-demand access by WEB users as illustrated by a directional arrow labeled I-Mag WEB server.

It will be apparent to one with skill in the art that there may be more or fewer software modules present in the functional layers illustrated herein without departing from the spirit and scope of the present invention. For example, an additional software module for detecting commercials (not shown) may be provided to execute as part of the function of layer 633. Such a module may use a number of methods for determining the presence of a commercial. Among these are traditional SCD color variance or sound variance technologies. Such a module for detecting commercials may also be provided at the front of the CC processing sequence and note the commercials by the absence of CC captions.

The method and apparatus of the present invention may be used in the preprocessing of any video content accompanied by CC text. Moreover, rules governing the method of mining CC text and what parts of the text are compared in determining topic or story line changes may vary widely according to desire and material content.

Automated URL Linking

In another aspect of the present invention, the inventor teaches a method for obtaining hyperlinks through the mining of CC text from a raw video segment. The method and apparatus of this invention in preferred embodiments is described in enabling detail below.

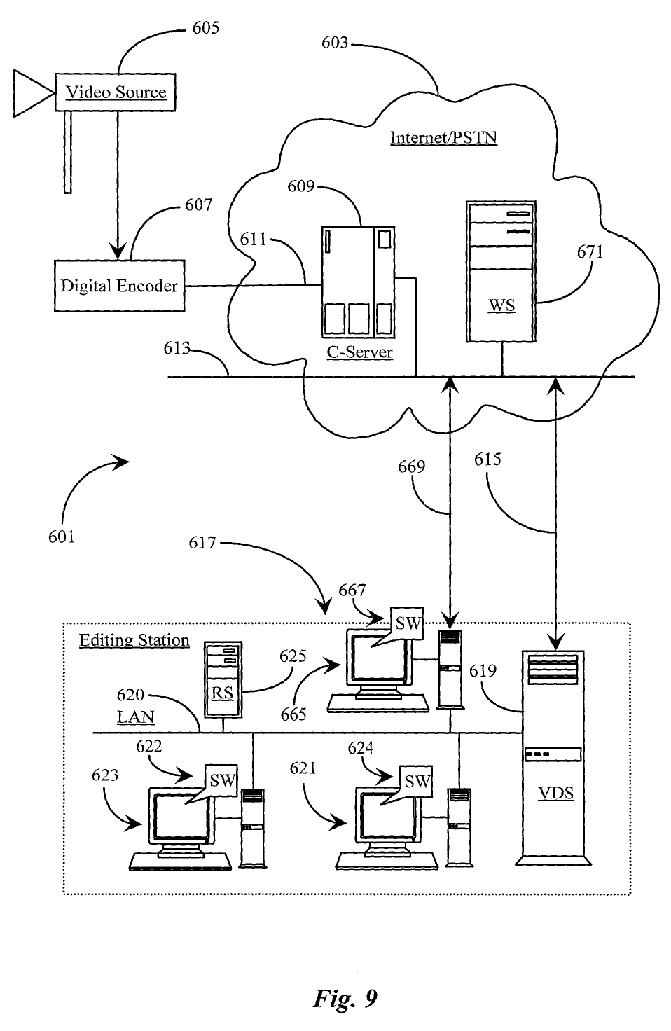

FIG. 9 is an architectural overview of the off-line video collection and editing process of FIG. 6 enhanced with automated search capabilities according to an embodiment of the present invention. As described above with reference to FIG. 6, architecture 601 represents a preferred mix of network architecture and equipment capabilities used to collect raw video content, pass the content to off-line editing, and distribute finished video presentations (I-Mag) to Internet locations from whence users may download and view such presentations.

In the description of FIG. 6, it is taught that SW instances 622 and 624, running on workstations 623 and 621, are used in cooperation with each other to mine CC text from raw video content and use certain words and phrases of that text to identify topic or story-line changes in the video. Once identified, the topic or story-line changes are represented by generated thumbnails depicting frames from the video that coincide with the changes in topic or story-line.

The generated thumbnails are interactive as described with reference to FIGS. 7 and 8 such that one may jump to the position in the video represented by a thumbnail by interacting with the thumbnail. Also, summary text taken from original CC text is associated with each thumbnail such that a user may obtain a brief description of the story or topic represented by the thumbnail. Text summaries are made available by interaction with a thumbnail such as by mouseover, which causes the summary to appear in an adjacent window as described with reference to FIG. 8, describing window 663 within interface 659.

Using the same CC text mining process described with reference to FIGS. 6 and 7 above, users may be provided with hyperlinks to URLs which are related to a story or topic currently being viewed. To that end, an additional workstation 665 is provided within editing station 617 and connected to LAN 620. Editing station 665 has an instance of software 667 provided to execute thereon and adapted to allow automated network data-search capability based on mined CC text keywords or phrases. In this embodiment, station 665 assumes the form of stations 623 and 621 in that it is a computer comprising GUI and a processor with enough power to perform the needed functions.

Station 665 has an Internet connection capability through an Internet access line 669. Line 669, in a preferred embodiment, represents a continuous Internet connection from station 665 to Internet backbone 613. However, a continuous connection is not required in order to practice the present invention. Line 669 may represent a dial-up connection that may be automated upon command to facilitate periodic on-line access for station 665. In an alternative embodiment station 665 may use VDS 619 for Internet access through access line 615 instead of having a dedicated (specific to station 665) connection.

A Web server (WS) 671 is illustrated within Internet cloud 603 and is adapted as a file server hosted by an exemplary Internet data-search provider. As such, WS 671 is adapted to serve hyperactive links (hyperlinks) to URLs indexed within a connected database (database not shown) as is generally known in the art. A search engine (not shown) running on WS 671 provides network data-search capability to interfacing nodes such as station 665 running SW 667, which contains an interface (search function) to WS 671.

It will be apparent to one with skill in the art that there may be many WS's such as server 671 connected to backbone 613 and accessible to station 665 without departing from the spirit and scope of the present invention. The inventor chooses to illustrate only one such server and deems that one server is sufficient for explaining the practice of the present invention. Access to many servers similar to WS 671 may be accomplished by including the appropriate interface mechanisms within SW 667 executing on station 665.

Practice of the present invention is virtually identical to the method described in FIG. 6 up to a point wherein automated search function is initiated. For example, raw video from source 605 is encoded for Internet transmission by encoder 607. The digital video content and CC text content is uploaded to C server 609 by virtue of Internet access line 611. VDS 619 downloads the content from C-server 609 by virtue of Internet access line 615. The “work” comprising digital video for editing and associated CC text files are distributed to stations 623 (CC text processing) and 621 (video processing) over LAN 620 as described above with reference to FIG. 6.

CC text results from station 623 are, in this enhanced embodiment, passed to workstation 665 as well as workstation 621. In this way, CC text results may be used for data-search purposes. Keywords such as nouns and/or phrases used to determine topic changes and keyframe selection at station 621 by virtue of SW 624 are also used simultaneously by station 665 running SW 667 to search WS 671 within Internet 603 for links to related URLs.

SW 667 is integrated by automated interface with SW instances 622 and 624 such that keywords or phrases passed to station 665 are automatically entered into a search function or functions facilitated by SW 667, at which time an automated data-search process is initiated. Results obtained in the data-search are automatically passed to station 621 where they are integrated into the keyframe selection, summary process, and thumbnail generation. VDS 619 receives edited video content in the form of a complete I-Mag presentation and uploads the content to an appropriate I-Mag server (not shown) connected to backbone 613 in Internet 603, from whence users may have access to the presentation.

In one embodiment, SW instances 622, 624, and 667 may be of the form of a single application executing on one powerful server/workstation. In this embodiment, however, each instance performs a separate part of the editing process using separate processors in a timed and controlled fashion through automated integration.

The added enhancement of automated data-search capability provided, in this embodiment, with the addition and integration of workstation 665 running SW 667 into the editing process allows for complete automation with regard to searching for and providing URL links to appear within an I-Mag video presentation during interaction with the presentation. Such reference links appear in user-interface 659 (FIG. 8) in a pop-up window or other interactive display mechanism assigned to a specific thumbnail to which the links are related. Without the CC text processing capability and the automated search function, a video editor would be required to view the video presentation and manually search for related URLs based on keywords or phrases supplied by the human editor.

The method and apparatus of the present invention allows a human editor to focus on other aspects of video editing not related to scene change detection or supplication of WEB-based reference material into an I-Mag presentation. Considerable resource and time otherwise required effect a successful editing process for an I-Mag video presentation may be eliminated by practicing the enhanced editing process as taught herein.

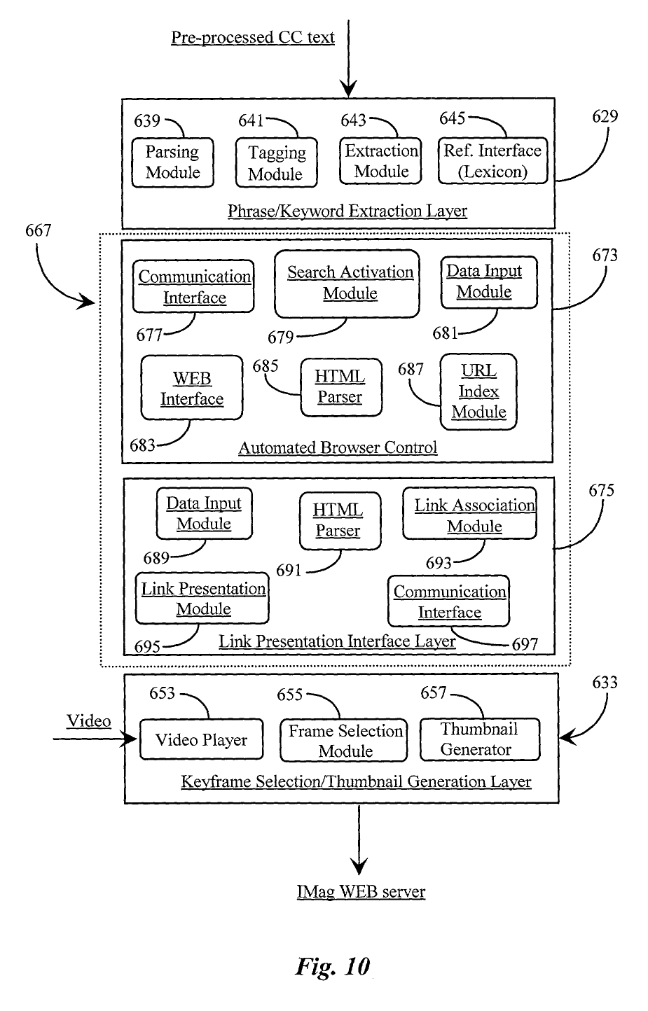

FIG. 10 is a block diagram illustrating an automated hyperlink search and linking process according to an embodiment of the present invention. In this embodiment, SW 667 is illustrated as interfaced between or layered in-between Phrase/Keyword Extraction Layer 629 (also shown in FIG. 7) and Keyframe Selection /Thumbnail Generation Layer 633 (also shown in FIG. 7). This fact is not to be construed as a limitation, but rather as a preferred embodiment wherein data-search functions and result integration into an I-Mag editing sequence is, by command, executed at optimal periods during the process as a whole.

SW 667 comprises at least two functional layers illustrated herein as layer 673 and layer 675. Layer 673 is adapted as an automated browser-control layer for providing automated interface to WEB navigation and data-search functions. Layer 675 is adapted as a link presentation interface layer for compiling, organizing and passing reference links to layer 633.

In describing this example of SW 667 and its integrated function, it is noted herein that before SW 667 may be utilized, layer 629 (SW 622) must first extract keywords and phrases from pre-processed CC text received from CC pre-processing layer 627 (FIG. 7). SW 667 then, receives extracted keywords and phrases from layer 629 as is illustrated herein. It is assumed for this example that the keywords and or phrases passed to layer 673 are in sufficient form for entry into a search dialog interface.

Layer 673 has a communication interface 677 provided therein and adapted to allow communication between layer 629 and layer 673. It is noted that layer 629 is located on workstation 623 and is part of SW 622 (FIG. 6). Layer 629 also may be assumed to have a communication interface provided therein though none is shown in this example. When layer 629 has extracted keywords and phrases for delivery, it calls layer 673 over LAN 620 and establishes a communication channel through which the keywords and phrases are transmitted. Keywords and phrases passed to layer 673 are presentation time stamped and tagged with identification as to which video segment they belong to.

Layer 673 has a search activation module 679 provided therein and adapted to execute a provided search-function interface upon notice of an impending data-search requirement through interface 677. If a continuous Internet connection is established for the data-search function, then a variety of search functions may already be activated such that only data input and search execution is required. In this example, SW 667 running on workstation 665 does not utilize a continuous Internet connection, but automatically accesses the Internet when required by an impending job.

Upon activation of module 679, an automatic Internet log-on is achieved and navigation to the appropriate search provider, in this case WS 671 of FIG. 9 is accomplished. A data input module 681 provides a mechanism for imputing keywords and phrases into search engine dialog boxes. A WEB-interface module 683 is provided and adapted to maintain a seamless cooperation between any connected WS/servers and SW 667.

An HTML parser 685 is provided and adapted to recognize queries as well as URL and HTML data returned from the network. Parser 685 may also be adapted to restructure a query or refine keywords in order to aid or optimize the search engine being used. A URL index module is provided within layer 673 and adapted to associate a URL or a group of URLs to a selected keyword or phrase. This process is known in the art wherein a hyperactive link is created and associated with a selected URL or group of URLs. The link appears as a different-colored text word or phrase that, when selected, invokes the associated URL or causes a list of actual URLs to appear.

It is important to note herein that URLs returned by a search engine as a result of a specific keyword or phrase used to find them are indexed to that keyword or phrase so that it is known during further editing which PTS (position in a video segment) and which video segment the URLs are associated with. The URL links are delivered along with the CC text words or phrases that were selected for the data search. Those words and phrases are the same words and phrases used to determine story-line or topic changes as described in the priority application cross-referenced above.

Once URLs are tagged as belonging to the appropriate keywords and phrases, the data is input into layer 675 by virtue of a data input module 689 provided therein and adapted for the purpose. Included in the data sent to layer 675 are URLs and selected keywords and phrases. In one embodiment, data resources other than search engine databases may be searched according to selected keyword or phrase such that instead of a URL, an HTML data block or page may be provided. In this case, an HTML parser 691 is provided within layer 675 and adapted to read the HTML data input into layer 675. Such data would be associated with the specific keyword or phrase used to obtain it as described with URL links.

A link association module 693 is provided within layer 675 and adapted to sort or reorganize URL links and HTML data to the specific keywords and phrases used to obtain them to insure that any created links are associated with the correct URLs. For example, the phrase “tornadoes in Kansas” may be extracted from CC text accompanying a story about a series of devastating tornadoes in Kansas and may be used to obtain hyperlinks linking to, for example, a weather site of the Kansas area, a site about tornadoes in general, and a site about safety precautions that need to be taken during a tornado. The three URLs are indexed to the phrase “tornadoes in Kansas” by index module 687 in layer 673. In layer 675, they are sorted and grouped by module 693 according to criteria used in indexing.

A link presentation module is provided within layer 675 and adapted to present URL/CC text data-groups that are packaged together such that they may be communicated over a network as intact data entities or files. A communication interface 697 is provided to establish communication from layer 675 to layer 633 over LAN 620 (FIG. 9). It may be assumed that a suitable communication interface module is provided in layer 633 as well although none is shown.

Layer 633 functions as described in FIG. 7 above concerning determination of keyframe selection and thumbnail generation according to extracted keywords and phrases, which are tagged as to PTS and segment ID. URLs accompanying extracted keywords and phrases from layer 675 are associated to the appropriate keyframes and generated thumbnails that indicate topic changes.

It will be apparent to one with skill in the art that the functional modules presented herein represent software means for accomplishing various stages in the editing process of the present invention. The inventor intends that SW 667 perform as an integral component of SW instances 622 and 624 of FIG. 6. This, of course may be accomplished through seamless integration of the various instances running on separate machines or, if desired, by providing a single application running on one powerful machine.

It will also be apparent to one with skill in the art that the process of searching for links to URLs based on selected words and/or phrases extracted from raw CC text as demonstrated by SW 667 may or may not be initiated before keyframes are selected for generating thumbnails depicting story-line changes without departing from the spirit and scope of the present invention. For example, after story-line change is determined, and a thumbnail is generated depicting the change, a data search may then be initiated using only those keywords or phrases describing the generated thumbnail. There are many possibilities.

In one embodiment, only certain selected words or phrases from CC text extracted are used in a data search. For example, a story may have several nouns, which are continuously repeated throughout a video segment. Such nouns that are most prevalent and represent main topics or nouns of interest would be used in a data search. Lesser nouns appearing in the video segment may not be selected for data search although they are utilized in conjunction with other nouns for determining story-line change.

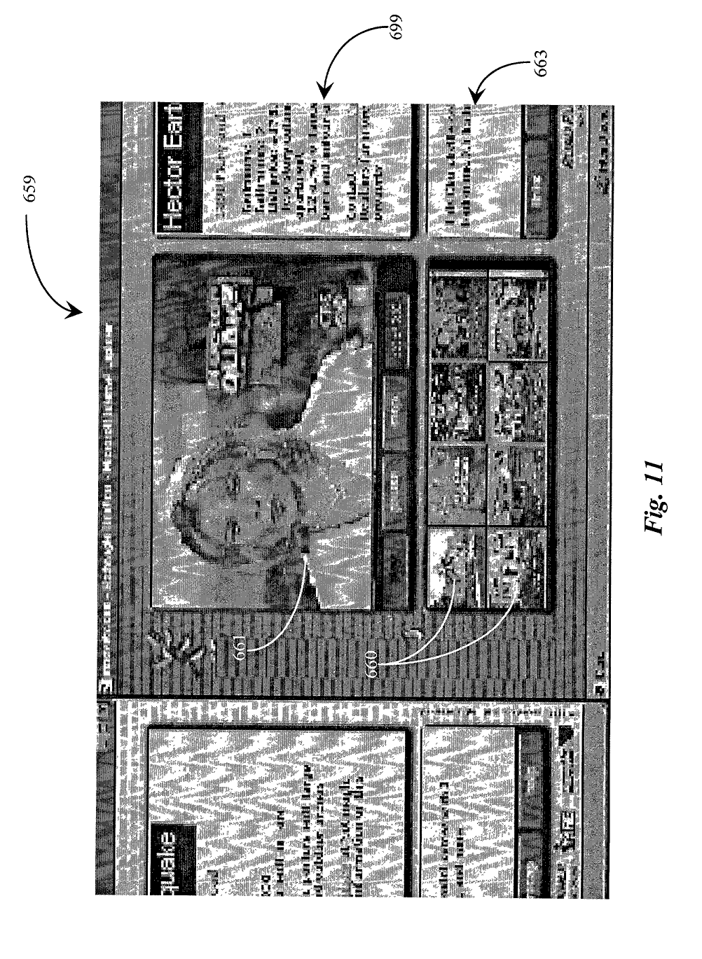

FIG. 11 is a screen shot of the I-Mag user-interface of FIG. 8 further illustrating a section adapted to contain interactive links to URLs according to an embodiment of the present invention. As previously described with reference to FIG. 8, I-Mag 659 appears on a user's monitor display as a video presentation with interactive controls and features accessible through cursor movement and selection. In this example, a news story about an earthquake is playing in a main window 661. Generated thumbnails 660 representing topic changes selected by mining CC text within the story of the earthquake appear below main window 661 and are placed in logical order from top-left to bottom right. If there are more thumbnails than may fit in the area provided for the purpose, then a scroll feature may be added to allow a user to scroll through additional thumbnails.

In this example, a separate window 699 is provided and adapted to contain hyperlinks associated with URLs of sites and other information related to one of thumbnails 660. When a user does a mouse-over to a desired thumbnail 660, information block 663 appears with summary text information related to the thumbnail as previously described. Window 699 appears if the desired thumbnail is selected by mouse click and a user progresses to that portion of the I-Mag presentation.

Window 699 may also contain links, which may appear in the form of the actual keywords or phrases used to find related URLs, or in another graphic form is iconic hyperlinks. The keywords or phrases, or other indicia may be highlighted by being a different color than other text appearing in window 699. Selecting one of the highlighted keywords or phrases or indicia may bring up a scrollable list (not shown) of related URL links.

In another embodiment, all of the related URL links may simply appear in window 669 when a desired thumbnail is selected or when an I-Mag naturally progresses to the segment represented by the thumbnail. When a user selects a link from this list, the video pauses while the user navigates on-line to the selected URL. After on-line interaction with the WEB-page addressed by the selected link, a user may close the page and continue viewing the I-Mag presentation from the point where it was paused.

In still another embodiment, on-line navigation may take place in a separate browser window such that a user may interact with WEB-pages addressed by the selected URL's while continuing to watch the I-Mag presentation (not pausing it).

The method and apparatus of the present invention provides users interacting with an I-Mag presentation with a means for “jumping” from topic to topic by selecting thumbnails wherein a summary of the topic (window 663) appears as well as additional reference data and links (window 699) to topic-related data held in this example, on the Internet.

In still another embodiment, topic-summary information, reference data, and hyperlinks may be caused to appear in a same window. The method and apparatus of the present invention may be practiced in many different ways utilizing a variety of architectures. For example, private individuals may download an I-Mag presentation from the Internet and interact with the provided links while connected on-line. Corporate individuals may practice the present invention on a WAN or LAN connected to the Internet and adapted with standard Internet communication protocols. There are many possibilities. The method and apparatus of the invention should thus be granted broad latitude and be limited only by the claims, which follow.

What is claimed is:

1. A system for finding URLs for sites having information related to topics in a video presentation, comprising:
an extractor extracting closed-caption (CC) text from the video presentation;
a parser parsing the CC text for topic language; and
a search function using the topic language from the parser as a search criteria;
characterized in that the search function searches for WEB sites having information matching the topic language, returns URLs for WEB sites found, and associates the URLs with the topic language.

2. The system of claim 1 further comprising a hyperlink generator for creating hyperlinks to the WEB sites returned, and displaying the hyperlinks with a display of the video presentation.

3. The system of claim 2 wherein the video presentation is provided in a first window in the display, thumbnails are displayed in a second window, each thumbnail representing a new topic, and the hyperlinks are displayed in a third window.

4. The system of claim 3 wherein the hyperlinks are displayed in the third window when the video presentation in the first window is in the particular topic related to the hyperlinks.

5. The system of claim 3 wherein the hyperlinks are displayed in the third window when a user does a mouseover of a thumbnail representing the topic to which the hyperlinks are related.

6. A method for finding URLs for sites having information related to topics in a video presentation, comprising steps of:
(a) extracting closed-caption (CC) text from the video presentation;
(b) parsing the CC text for topic language;
(c) using the topic language from the parser as a search criteria in a search engine;
(d) returning URLs for WEB sites matching the search criteria; and
(e) associating the returned URLs with the topic language.

7. The method of claim 6 further comprising a step for generating hyperlinks to WEB sites returned, and displaying the hyperlinks with a display of the video presentation.

8. The method of claim 7 wherein the video presentation is provided in a first window in the display, thumbnails are displayed in a second window, each thumbnail representing a new topic, and further comprising a step for displaying the hyperlinks in a third window.

9. The method of claim 7 comprising a further step for displaying the hyperlinks in the third window when the video presentation in the first window is in the particular topic related to the hyperlinks.

10. The system of claim 7 comprising a further step for displaying the hyperlinks in the third window when the user does a mouseover relative to one of the thumbnails representing a particular topic.
